(19) United States
(12) Patent Application Publication
(10) Pub. No.: US 2017/0268990 A1
(43) Pub. Date: Sep. 21, 2017

(54) SEPARATING DIFFUSE AND SPECULAR COMPONENTS OF A GLOSSY OBJECT FOR SHAPE RECONSTRUCTION USING ELECTRONIC LIGHT DIFFUSING LAYERS (E-GLASS) AND POLARIZED LIGHT

(71) Applicant: CANON KABUSHIKI KAISHA, Tokyo (JP)

(72) Inventors: MANUEL MARTINELLO, Mountain View, CA (US); MAHDI NEZAMABADI, San Jose, CA (US)

(21) Appl. No.: 15/359,404

(22) Filed: Nov. 22, 2016

Related U.S. Application Data
(60) Provisional application No. 62/309,897, filed on Mar. 17, 2016.

(51) Int. Cl. G01N 21/21; G01B 11/02

(52) U.S. Cl. CPC G01N 21/21; G01B 11/02

(57) ABSTRACT

3D shape reconstruction of glossy objects includes separation of diffuse and specular components of reflection from the object. Multiple layers of E-glass arranged in spaced-apart relation with each other, together with a camera for capturing images of reflected light. A first polarizer is positioned to polarize incident light before it reaches the object and a second polarizer is configured as an analyzer to analyze the light reflected from the object. The degree of polarization is varied. Images are captured of a structured light pattern as reflected in both diffuse and specular reflection the surface of the glossy object. A diffuse component of reflection is extracted by using the captured images of the deformed patterns, and a specular component of reflection is extracted by using the diffuse component of reflection and the captured images under polarized illumination. Depth of the surface of the object is estimated by fusing the diffuse component and the specular component.

### CROSS REFERENCE TO RELATED APPLICATION

This application claims priority from U.S. Provisional Application No. 62/309,897, filed Mar. 17, 2016, the contents of which are incorporated by reference herein as if set forth in full.

### FIELD

The present disclosure relates shape reconstruction of physical objects using structured light and multiple electronically-controllable light diffusing layers, and is particularly well-suited for shape reconstruction of objects having glossy surface with reflection characteristics having both diffuse and specular components.

### BACKGROUND

Gloss is an optical property which indicates how well a surface reflects light in a specular (mirror-like) direction. Apparent gloss depends on the amount of specular reflection (light reflected from the surface with the same spectrum and the symmetrical angle to the one of incoming light) in comparison with diffuse reflection (the amount of light scattered into other directions).

FIG. 1 is an illustration depicting reflection characteristics of incident light on the surface of a glossy object. When incident light hits the surface of a glossy object, both specular and diffuse components are reflected and can be captured by a camera.

In the captured image of a glossy object, the captured intensity I_{G} can be expressed as the sum of the specular and the diffuse components:

I_{G}=Iₛ+I_{d}

There are two extreme cases:

Case a: If there is no specular reflection (Iₛ=0), the object is called diffuse;

Case b: If the specular reflection corresponds to the total amount of reflection that is captured (I_{G}=Iₛ), the object is called specular or mirror-like object.

Most real-world objects are neither completely diffuse nor completely specular, and their reflection characteristics thus exhibit both diffuse and specular components.

In the field of shape reconstruction of objects, it has therefore been considered by some to separate the specular and diffuse components. Several techniques have been designed to separate specular and diffuse components using polarization (such as in [1,2,3]), especially with the goal of eliminating undesired specular reflectance (e.g., in [1]) or estimating normal (e.g., in [3]), but not absolute 3D position.
[1] V. Mueller, Elimination of specular surface-reflectance using polarized and unpolarized light, European Conference on Computer Vision (ECCV), 1996.
[2] S. Umeyama and G. Godin, Separation of diffuse and specular components of surface reflection by use of polarization and statistical analysis of images, IEEE Transactions on PAMI, Vol. 26(5), 2004.
[3] B. Lamond, P. Peers, A. Ghosh, P. Debevec, Image-based separation of diffuse and specular reflections using environmental structured illumination, IEEE International Conference on Computational Photography (ICCP), 2009.

One arrangement for profiling specular objects is proposed in U.S. patent application Ser. No. 14/489,008, filed Sep. 17, 2014, “Depth Value Measurement Using Illumination by Pixels” (Attorney Docket No. 03650.017146). As described there, a specular object is illuminated by area illumination from patterns formed on multiple LCD layers, which are in a known or calibrated spaced-apart configuration. The patterns form a code that can be used to identify a ray connecting from a first pixel in one layer through a second pixel in another layer. Because the spacing of the layers is known or knowable, the ray allows disambiguation of the surface-normal ambiguity, thereby permitting successful surface profiling of specular objects. On the other hand, if the object is not sufficiently mirror-like, the diffuse components of reflection from the object may tend to alter the ability to read the coded rays, and therefore may tend to decrease accuracy of the technique.

Recently, consideration has also been given to arrangements using multiple E-glass layers that can reconstruct the shape of both specular and diffuse objects using the same device. See U.S. patent application Ser. No. 15/072,116, filed Mar. 16, 2016, “3D Shape Reconstruction Using Reflection Onto Electronic Light Diffusing Layers” (Attorney Docket No. 03650.018645); and U.S. patent application Ser. No. 15/072,101, filed Mar. 16, 2016, “3D Shape Reconstruction Using Projection Onto Electronic Light Diffusing Layers” (Attorney Docket No. 03650.018620). All three of these applications are assigned in common herewith, and all three are incorporated by reference herein as if set forth full.

### SUMMARY

From the foregoing, it will be understood that shape reconstruction methods for diffuse objects are not accurate when objects have a visible specular component.

On the other hand, it will further be understood that shape reconstruction methods for specular objects can ordinarily be used only for mirror-like objects or objects with a very strong specular component as compared to the diffuse component.

Some approaches use polarized light to extract the specular component of a highly glossy object and estimate its normals (see [3]), but the absolute 3D position of the object points cannot be reconstruct.

Systems based on E-glass layers can reconstruct both specular objects (by displaying a pattern on diffuse layers) and diffuse objects (by projecting a pattern directly onto the objects). However, these systems still have some difficulties when dealing with glossy objects since there are mixed components of diffuse and specular reflection.

The disclosure herein describes arrangements that are able to separate diffuse and specular components in an E-glass based system, for accurate shape reconstruction of glossy objects. In general, an E-glass-based system uses a pair of polarizers, one to polarize light and the other to analyze polarization in the reflected light. The polarizers are controlled so as to be able to separately identify the diffuse component and the specular component of reflection, whereafter the separated diffuse and specular components can then be given as input to different shape reconstructions.

Thus, in one aspect described herein, diffuse and specular components of reflection from a glossy object involves at least two transparency controllable layers, which can be set to either transparent or diffuse, and at least one projector to project patterned light, whereby patterned light is projected onto the object when the E glass layers are both set to transparent and onto the layers when at least one of the layers is set to diffuse. A camera captures images of light reflected from the glossy object. At least one polarizer is provided to polarize the incident light before it reaches the glossy object, and at least one analyzer is provided to analyze the light reflected from the object.

Both the polarizer and the analyzer may be circular or linear. The polarizer and the analyzer may be configured to rotate relative to each other, such as a configuration where the polarizer is fixed and the analyzer rotates, or where the polarizer rotates and the analyzer is fixed.

According to further aspects, diffuse and specular components of reflection from a glossy object are separated for shape reconstruction, in which first and second transparency-controllable layers are controlled between a transparent mode in which the layer is transparent and a diffuse mode in which the layer diffuses light. Patterned light is projected from a projector, and images of the object are captured with different angles of polarization. The captured images are used to extract a diffuse component of reflection, and the captured images and the diffuse component of reflection are used to extract a specular component of reflection.

All the layers may be set to transparent and the pattern is projected directly onto the target object. Likewise, only one layer may be set to diffuse and all the other layers set to transparent, and the projected pattern is displayed on the diffuse layer. Multiple images such as N images may be captured for each layer.

According to further aspects described herein, shape reconstruction may include shape reconstruction of diffuse objects, shape reconstruction of specular objects, and a combining of the shape reconstruction of diffuse objects and the shape reconstruction of specular objects by using a weighted average. The weights may be extracted using a ratio between intensities of the specular and the diffuse components. Likewise, the weights may be computed at each pixel, or they may be constant for the entire image.

According to further aspects, depth estimation of the surface of an object positioned at an inspection station may involve first and second transparency-controllable layers, the first and second layers being positioned in spaced-apart relation relative to each other, wherein both of the first and second layers are controllably switchable between a transparent mode in which the layer is transparent, and a diffuse mode in which the layer diffuses light. A projector may be positioned and configured to project patterned light, whereby the inspection station is illuminated with patterned light. An image capture device may be positioned and configured to capture images of light reflected from an object at the inspection station. First and second polarizers may be positioned such that the first polarizer is positioned to polarize incident light before it reaches the object and the second polarizer is configured as an analyzer to analyze the light reflected from the object. A controller may be configured (i) to control transparency of the first and second layers and to control projection of patterned light by the projector, (ii) to control at least one of the first polarizer and the second polarizer so as to vary polarization of light, (iii) to separate diffuse components of reflected light from specular components of reflected light by calculations using images of the object captured by the image capture device, and (iv) to estimate depth of the surface of an object positioned at the inspection station.

The captured images may be used to extract the diffuse component, and the captured images and the diffuse component may be used to extract the specular component. The controller may be further configured to reconstruct shape based on the diffuse component and to reconstruct shape based on the specular component, and to fuse the shape reconstruction based on the diffuse component and the shape reconstruction based on the specular component. Fusing may use a weighted average of the shape reconstruction based on the diffuse component and the shape reconstruction based on the specular component. The weights may be extracted using a ratio between intensities of the specular and the diffuse components.

The projector may be positioned to project patterned light toward the second transparency-controllable layers, or the projector may be positioned to project patterned light toward the inspection station.

According to further aspects, depth of the surface of an object may be estimated by controlling first and second transparency-controllable layers between a transparent mode in which the layer is transparent and a diffuse mode in which the layer diffuses light, wherein the first and second layers are positioned in spaced-apart relation relative to each other. A first sequence of light patterns is projected while the first layer is in the diffuse mode and the second layer is in the transparent mode, wherein the object is illuminated with the projected light patterns. Similarly, a second sequence of light patterns is projected while the first layer is in the transparent mode and the second layer is in the diffuse mode, wherein the object is illuminated with the projected light patterns. A degree of polarization of light incident on the object is varied, and the first and second sequences are repeated. Images are captured of deformed patterns reflected by the surface of the object during both repetitions of the first and second sequences, the images being captured through a polarization analyzer. With both layers in the transparent mode, the first and second sequences are repeated and images of the object under illumination are captured. A diffuse component of reflection is extracted by using the captured images, and a specular component of reflection is extracted by using the diffuse component of reflection and the captured images under polarized illumination. Depth of the surface of the object is estimated by fusing the diffuse component and the specular component.

Fusing may use a weighted average of the diffuse component and the specular component. The weights may be extracted using a ratio between intensities of the specular and the diffuse components.

By virtue of the example embodiments described herein, advantageous effects may include the ability to reconstruct the shape of all of specular objects, diffuse objects, and glossy objects, all using the same device and the same configuration.

In addition, advantageous effects of the separation of the diffuse and the specular components may include the use of the specular component with methods for shape reconstruction of specular objects; the use of the diffuse component with methods for shape reconstruction of diffuse objects; use of one or both components to extend shape estimation from specular objects to more generalized glossy objects (using the specular component) and/or to extend shape estimation from diffuse (or Lambertian) objects to more generalized glossy objects (using the diffuse component).

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is an illustration depicting reflection characteristics of incident light on the surface of a glossy object

FIG. 2 is a conceptual view of a circular polarizer.

FIG. 3 shows polarization reversal of circularly polarized light reflected by a specular surface.

FIG. 4A illustrates the parallel components of the incident, the reflected, and the refracted beam in specular reflection.

FIG. 4B is a graph of some representative coefficients of reflection of the parallel and the vertical component of the beam.

FIG. 5 is a view showing one example embodiment of a system for recovery of surface shape of glossy objects.

FIGS. 6A and 6B are views for explaining one principle by which the 3D shape of glossy objects can be recovered.

FIG. 7 is a view for explaining one embodiment of the architecture of a reconstructor for reconstruction of surface shape of objects.

FIG. 8A and FIG. 8B show examples of how intensity varies at a pixel of a glossy object depending on the angle of rotation of an analyzer, wherein FIG. 8A pertains to a highly glossy object while FIG. 8B pertains to an object with low glossiness.

FIG. 9 is a flowchart for explaining extraction of a diffuse component for surface reconstruction.

FIGS. 10A and 10B are flowcharts for explaining extraction of a specular component for surface reconstruction, in which FIGS. 10A and 10B correspond to the arrangements shown in FIGS. 6A and 6B, respectively.

### DETAILED DESCRIPTION

Before describing additional details, some important properties of polarized light and reflection are reviewed.

### Circular Polarizer

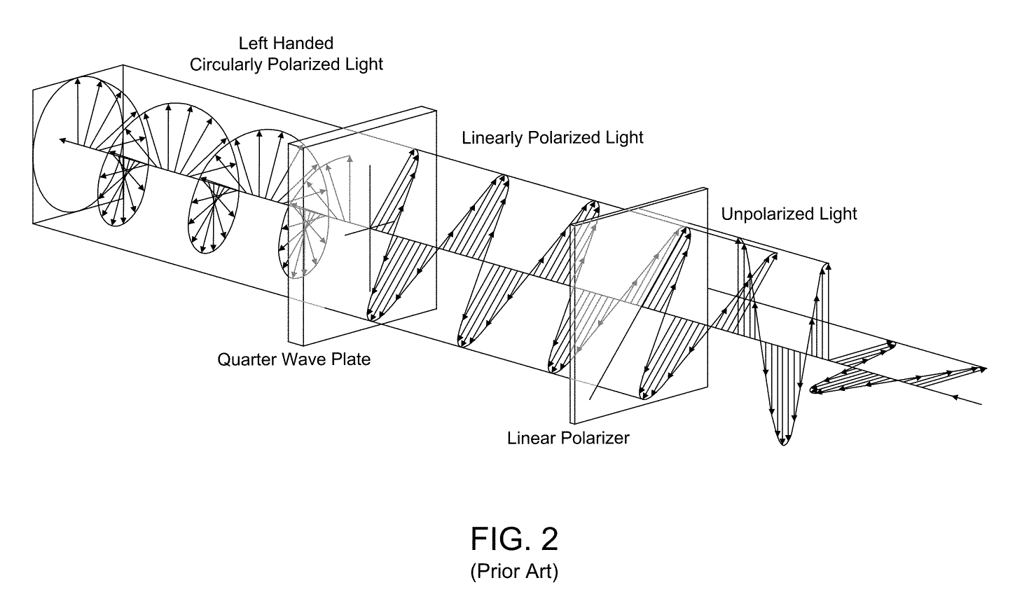

FIG. 2 is a conceptual view of a circular polarizer. A circular polarizer is in general formed by two elements: (a) a linear polarizer, and (b) a quarter wave plate. When unpolarized light goes through the two elements with this order (first the linear polarizer and then the quarter wave plate) the light becomes circularly polarized, as depicted in FIG. 2.

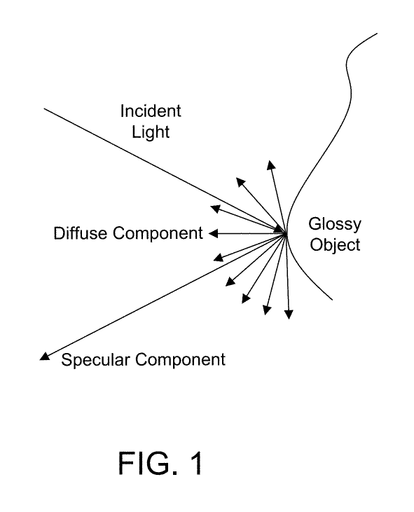

Some property of polarized light, with reference to the specular and diffuse components shown in FIG. 1:

Property 1: If the incident light in FIG. 1 is polarized, the specular component I^{s} is also polarized, while the diffuse component I^{d} loses the polarization.

Property 2: When the diffuse component I^{d} goes through an analyzer (linearly or circularly polarized), its intensity is reduced by half.

Property 3: When polarized light goes through an analyzer (with a given polarization) its intensity is reduced if the two polarizations do not match; specifically

(3a) In case of linear polarizations, the intensity of the light I measured after the analyzer depends on the angle θ between the two polarizations:

I=I₀ cos² θ

(3b) In case of circular polarizations there are two scenarios:

(3b1) if the senses (or handedness) of the two polarizations are different (e.g., one is right-handed and the other one is left-handed), the light is completely blocked;

(3b2) if the two polarizations have the same sense but the analyzer is reversed (light first goes through the linear polarizer and then through the quarter wave plate), then the measured intensity I would be half of the original specular component:

$$I = \frac{1}{2} {I}_{0}$$

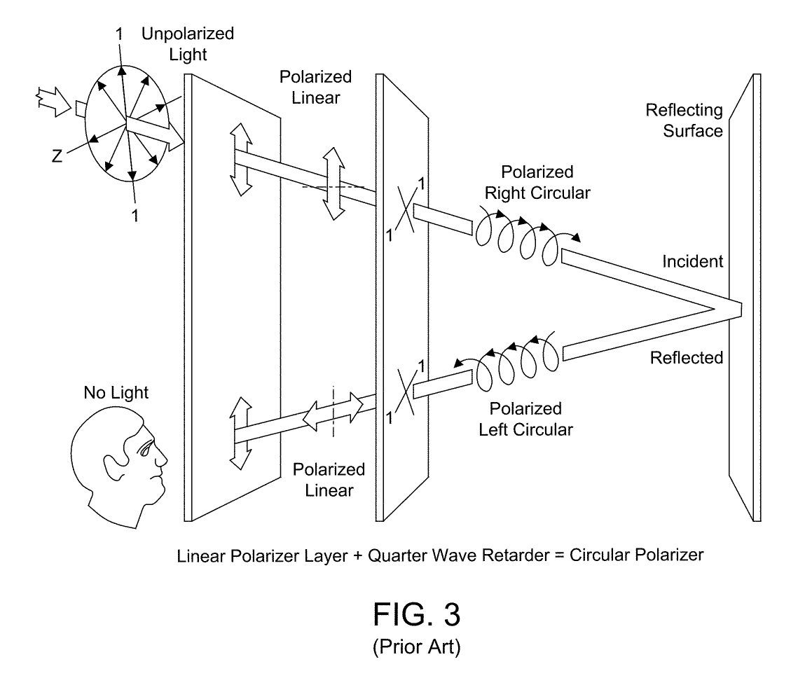

Property 4: When circularly polarized light is reflected by a specular surface, its polarization is reversed, i.e., from right-handed to left-handed or vice-versa. This is depicted in FIG. 3, which shows polarization reversal of circularly polarized light reflected by a specular surface.

Property 5: When circularly polarized light is reflected by a specular surface, the polarization of the reflected component is still circular only if the angle θ between the incident and the reflected specular component is small; in practice this is true for θ9<60°. In this regard, the following note on Fresnel Equations is pertinent. In this note, it will be understood that θ=2α.

Note on Fresnel Equations

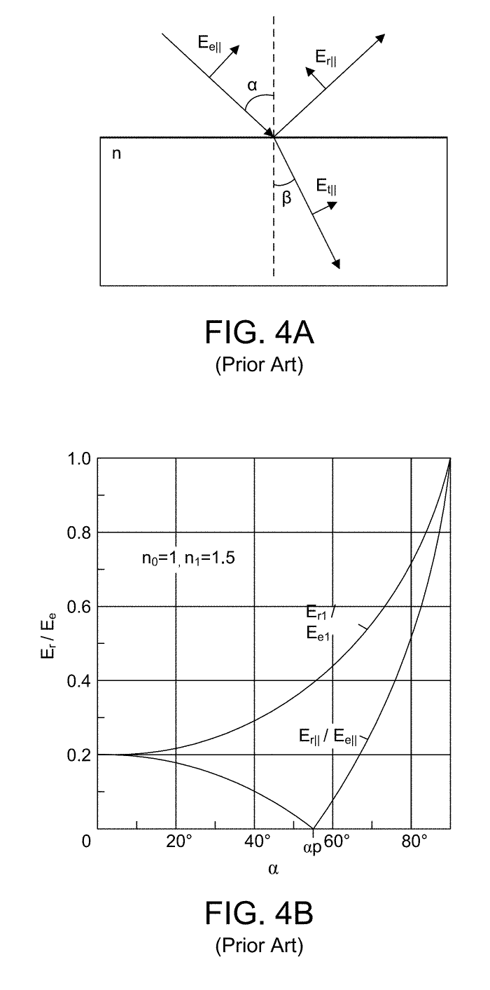

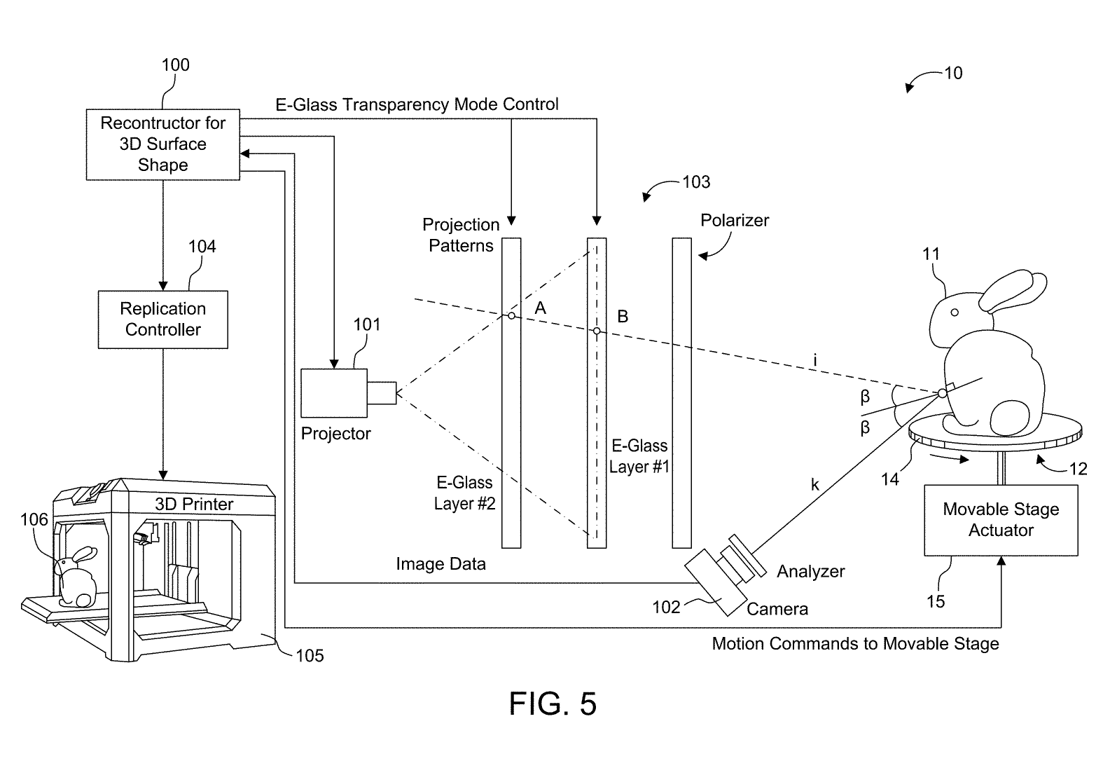

FIG. 4A illustrates the parallel components of the incident, the reflected, and the refracted beam in specular reflection. Based on FIG. 4A, and denoting the index of refraction of the material by n, specular reflection from the surface is governed by the Fresnel equations:

$${R}_{⊥} = \frac{{E}_{r ⊥}}{{E}_{e ⊥}} = \frac{sin ( β - α )}{sin ( α + β )}$$

$${R}_{‖} = \frac{{E}_{r ‖}}{{E}_{e ‖}} = \frac{tan ( β - α ) }{tan ( α + β )}$$

where R_{⊥} is the ratio of the reflected to incident electric field component perpendicular to the plane of incidence, and R_{∥} is the corresponding ratio for the parallel component; a is the angle of incidence and β is the refracted angle, given by:

$$β = arcsin ( \frac{1}{n} sin ( α ) )$$

Since the ratios R_{⊥} and R_{∥} differ, circular polarization typically becomes elliptical on reflection, especially when the angle α is not small. This can be understood from the graph in FIG. 4B.

FIG. 4B is a graph of some representative coefficients of reflection of the parallel and the vertical component of the beam, dependent on the angle of incidence a in a specular reflection for n=1.5. As can be understood from this graph, circular polarization typically becomes elliptical on reflection, especially when the angle α is not small.

### Hardware

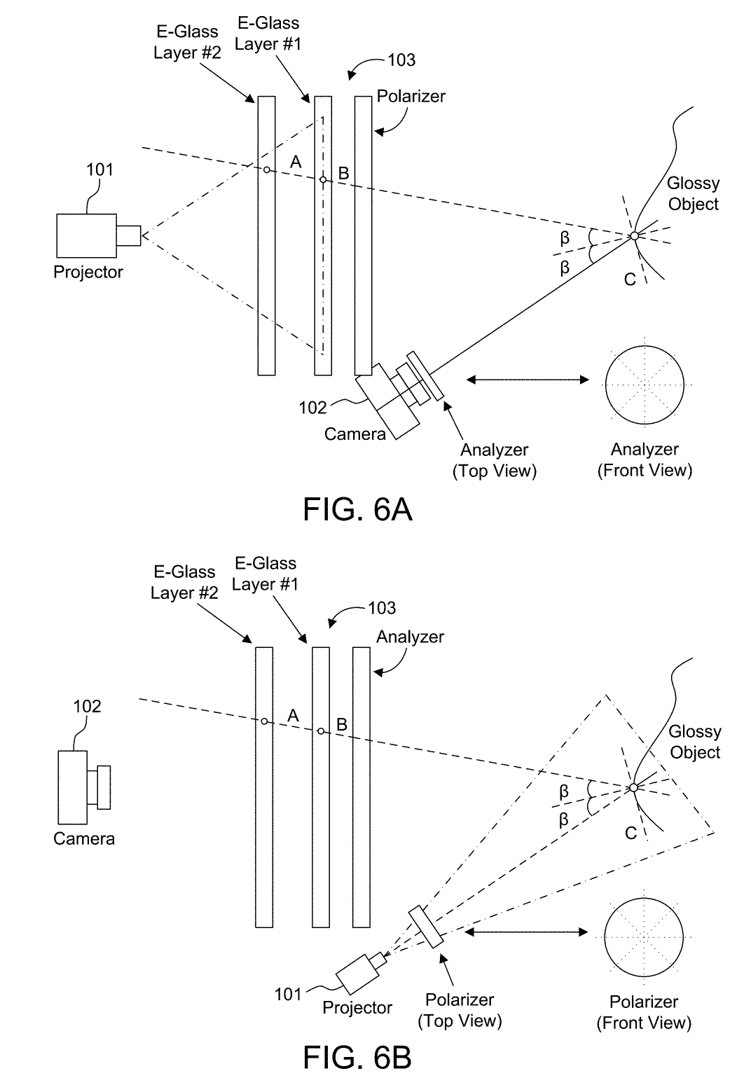

FIG. 5 is a view showing one example embodiment of a system for recovery of surface shape of glossy objects such as objects whose reflection characteristics include both a specular component and a diffuse component, in the form of a replication system 10 in which surface shape of objects is recovered for replication, for example, for 3D replication of the object physically (such as with a 3D printer) or representationally (as with a graphics display).

While FIG. 5 depicts a replication environment, it should be understood that this is simply an example environment in which the disclosure herein may be practiced, and that other environments or embodiments are of course possible. For example, recovery of surface shape can also be used in the context of automated inspection, robotics, gripping and positioning, machine vision, quality control, image retrieval, shape modelling and scene reconstruction, security and so forth, among many others.

As shown in FIG. 5, an object 11 is positioned at an inspection station 12, which in this embodiment is the surface of a movable stage 14 by which the object can be moved into varying perspectives. In this embodiment, the movable stage is movable by rotation about a vertical axis, and in other embodiments the movable stage may be a 3-axis positioning table. Object 11 is typically a specular object or a mirror-like object, or other similar object with a glossy or highly glossy surface. Movable stage 14 is moved under control of actuator 15, via motion commands issued by reconstructor 100 for reconstruction of surface shape.

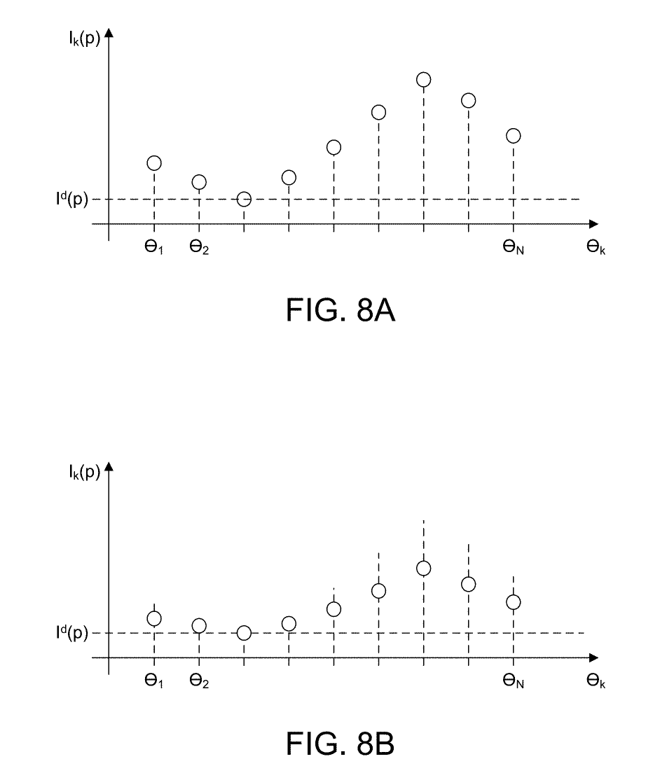

Reconstructor 100 is configured to reconstruct surface shape of objects at inspection station 12, based on commands issued to projector 101 and commands issued to actuator 15 for movable stage 14, and based on image data received from image capture system 102. Based on the reconstruction obtained by reconstructor 100, reconstructor 100 controls replication controller 104 so as to obtain a 3D replication of the object. In this embodiment, 3D replication of the object is obtained physically via 3D printer 105, to produce replicated object 106. In other embodiments, 3D replication of the object may be obtained representationally via a graphics display. More details of reconstructor 100 are provided below, such as in connection with FIG. 7.

FIG. 5 further depicts plural transparency-controllable layers 103, positioned in spaced-apart relation relative to each other. In the FIG. 5 embodiment, there are two spaced-apart layers and in other embodiments there may be three or more spaced-apart layers. Under control from reconstructor 100, each transparency controllable layer is independently switchable between a transparent mode in which the layer is transparent, and a diffuse mode in which the layer diffuses light.

For the plural transparency-controllable layers 103, this embodiment uses multiple layers of E-glass. As used herein, the term “E-glass” refers to electronically switchable glass which is switchable between a transparent mode in which the glass is completely transparent, and a diffuse mode in which the glass assumes a frosted appearance. Images can be projected or formed on the frosted appearance of the diffuse mode, and this property of E-glass is used to advantage in the configuration described herein. E-glass is sometimes referred to as “smart glass”, and the diffuse mode is sometimes referred to as opaque or translucent. One common use of E-glass is in the field of selectable privacy, such as in a conference room where the windows can be switched between an open transparent state and a private diffuse state.

E-glass is typically formed of a polymer dispersed liquid crystal (PDLC) or polymer stabilized cholesteric texture (PSCT) film sandwiched between two layers of glass with two layers of conductive interlayers, so as to allow control of the E-glass between the transparent mode and the diffuse mode. Other technologies for fabricating E-glass include suspended particle devices (SPDs) and electrochromic devices. For the E-glass used in this embodiment, the change-over from transparent mode to diffuse mode, and vice-versa, takes less than 10 seconds.

As used herein, E-glass refers to any of these or similar technologies, in which the transparency of a layer is controllable electrically between a fully transparent mode and a fully diffuse mode.

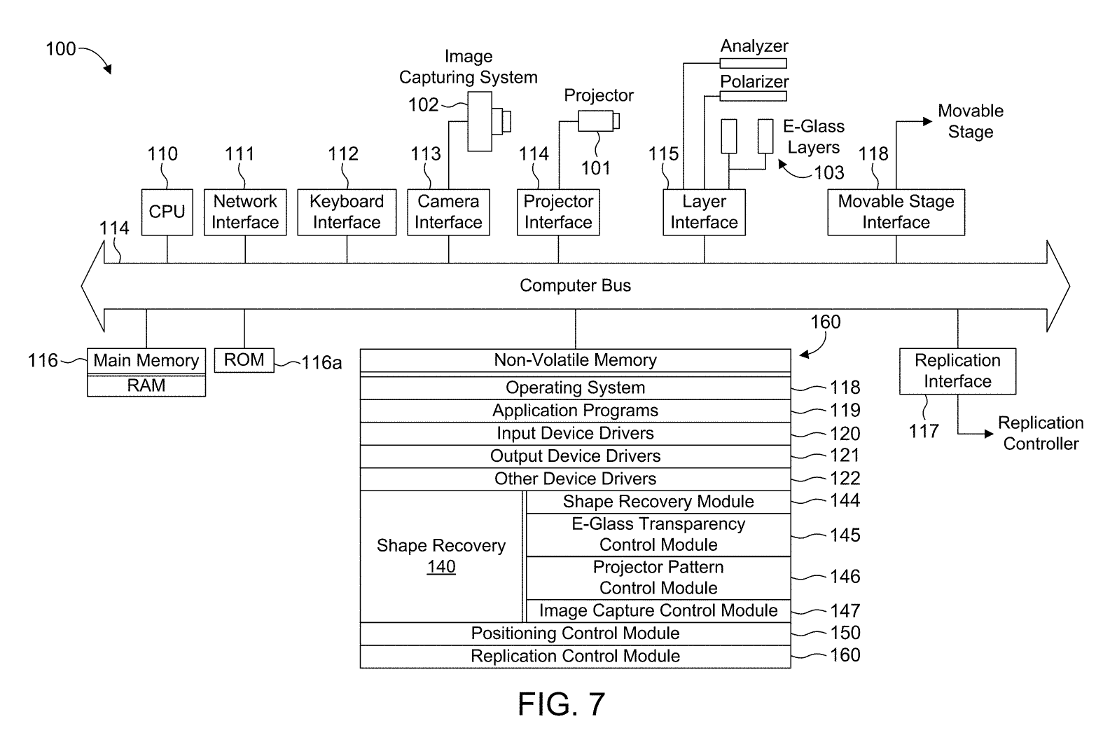

The E-glass layers are positioned in spaced-apart relation to each other, such that by using the relative postionings of the E-glass layers to projector 101 and camera 102, ray-tracing and/or triangulation techniques allow reconstruction of the 3D surface shape of the object 11 under inspection. The relative postionings are predetermined through calibration. More details on the relative positionings of E-glass layers 103, relative to other elements such as projector 101 and image capture system 102, are provided below such as in connection with FIGS. 6A and 6B. Calibration is described in the afore-mentioned application Ser. Nos. 15/072,116 and 15/072,101, which are incorporated by reference.

In addition to the plural E-glass layers 103, the FIG. 5 embodiment also includes a pair of polarizers, one configured to polarize light and the other configured to analyze polarized light. In the FIG. 5 embodiment, the first polarizer is positioned between the E-glass layers and the object, so as to polarize light illuminated toward the object. The second polarizer is positioned in front of camera 102 so as to permit analysis of the polarization state of light reflected from the object.

Projector 101 in this embodiment has an autofocus function, by which patterns projected by the projector are automatically focused onto the surface where the patterns are projected. This provides an advantageous benefit: because the transparency mode of the E-glass layers 103 is changed between diffuse mode and transparent mode, the surface onto which patterns are projected is likewise changed. For example, in a circumstance when an innermost E-glass layer is in the diffuse mode, patterns are projected onto the innermost layer. The focus distance in this circumstance differs from a circumstance when the innermost E-glass layer is in the transparent mode and the outermost layer is in the diffuse mode, where patterns are projected onto the outermost layer. Both of these focus distances are different from the circumstance when all E-glass layers are in the transparent mode, the object is diffuse, and patterns are projected directly onto the surface of the diffuse object. The autofocus function of projector 101 responds automatically to these changes in focus distance, ensuring that the projected patterns remain in focus regardless of the surface onto which they are projected.

FIGS. 6A and 6B are views for explaining one principle by which the 3D shape of glossy objects can be recovered, through control over the transparency modes of E-glass layers 103, and through control of the pair of polarizers. In these figures, projector 101, camera 102, and two layers 103 of E-glass are used to estimate surface normal vectors of a glossy object 11. The E-glass layers are controllable to either of transparent mode or diffuse mode by applying an electric signal from reconstructor 100. At each time, one of the layers is set to diffuse mode and all other layers are set to transparent mode, and a pattern sequence is projected onto the back of the layer in diffuse mode via projector 101. The glossy surface of object 11 reflects the patterns, and the reflections are distorted by the 3D shape of the surface of the object. These distorted reflections from object 11 are captured by camera 102 and used for estimation of the surface normal vectors and/or for estimation of 3D surface shape. It will be understood that surface normal and 3D surface shape are virtually interchangeable, inasmuch as 3D surface shape is the integral of surface normal, and surface normal is the derivative of 3D surface shape.

The position of camera and the E-glass layers are determined during a calibration process and stored for later computations. The correspondences between camera pixels and points on E-glass layers are established by projecting conventional coded patterns, different from each other, such that each pixel at the layer is uniquely identifiable. The patterns may, for example, be binary patterns of horizontal and vertical stripe patterns, each pattern in the sequence having a spatial frequency that differs from others of the patterns in the sequence, such as Gray code patterns.

For simplicity, all the arrangements in this section show use of only two E-glass layers. It will be understood that in general, the arrangements described herein work with M layers of E-glass, with M≧2.

As shown in the FIGS. 6A and 6B, a pair of polarizers is used, one as a polarizer to polarize the incident light before it reaches the object; and the other as an analyzer to analyze the light reflected off the object. Either the analyzer or the polarizer can rotate in both settings. In FIG. 6A, the analyzer is rotated, whereas in FIG. 6B, the polarizer is rotated.

As explained in greater detail below, to obtain a diffuse component of reflection from the object 11 at the inspection station, all E-glass layers are set to transparent mode, and projector 101 projects the patterns directly onto the surface of the diffuse object. Camera 102 captures images of the patterns, through all E-glass layers, and the captured images used for estimation of 3D surface shape. In principle (and the details are explained below) this allows the depth for each pixel of the object at the inspection station to be calculated based on traditional triangulation methodology, so as to obtain the diffuse component of reflection.

To obtain a specular component of reflection, each different layer of E-glass is set to diffuse mode with all others set to transparent mode, and projector 101 projects patterns with all others being in the transparent mode, so as to illuminate the object by the patterns projected onto the diffuse mode layer. Images are captured of the structured light pattern as reflected by the glossy surface of the object. In principle (and the details are explained below), by projecting multiple different patterns, such as multiple different Gray code patterns, and by sequencing through each E-glass layer for each pattern, the 3D shape of the entirety of the visible surface of the object can be reconstructed by analysis of captured images of the distorted reflections of the patterns by the surface of the object.

FIG. 7 is a view for explaining one embodiment of the architecture of reconstructor 100 for reconstruction of surface shape of objects at inspection station 12.

As shown in FIG. 7, reconstructor 100 includes central processing unit (CPU) 110 which interfaces with computer bus 114. Also interfacing with computer bus 114 are network interface 111, keyboard interface 112, camera interface 113 which interfaces to image capture system 102, projector interface 114 which interfaces to projector 101, E-glass interface 115 which interfaces to the plural E-glass layers 103, movable stage interface 118 which interfaces to actuator 15 of movable stage 14, random access memory (RAM) 116 for use as a main run-time transient memory, read only memory (ROM) 116a, replication interface 117 for interface to replication controller 104, and non-volatile memory 160 (e.g., a hard disk or other nonvolatile and non-transitory storage medium).

RAM 116 interfaces with computer bus 114 so as to provide information stored in RAM 116 to CPU 110 during execution of the instructions in software programs, such as an operating system, application programs, image processing modules, and device drivers. More specifically, CPU 110 first loads computer-executable process steps from non-volatile memory 160 or another storage device into a region of RAM 116. CPU 110 can then execute the stored process steps from RAM 116 in order to execute the loaded computer-executable process steps. Data also can be stored in RAM 116 so that the data can be accessed by CPU 110 during the execution of the computer-executable software programs, to the extent that such software programs have a need to access and/or modify the data.

As also shown in FIG. 7, non-volatile memory 160 contains computer-executable process steps for operating system 118, and application programs 119, such as graphic image management programs. Non-volatile memory 160 also contains computer-executable process steps for device drivers for software interface to devices, such as input device drivers 120, output device drivers 121, and other device drivers 122.

Non-volatile memory 160 also stores a shape recovery module 140, a positioning control module 150, and replication control module 160. These modules, i.e., the shape recovery module 140, the positioning control module 150, and the replication control module 160, are comprised of computer-executable process steps for recovery or reconstruction of 3D surface shape of an object, for repositioning of the object on movable stage 14, and for control of replication controller 104 for 3D replication of the object.

As shown in FIG. 7, shape recovery module 140 generally comprises calibration data 141 for determining angle of ray of light based on triangulation as the ray passes through the plural E-glass layers 103, and shape recovery module 144 for recovery of surface shape of the object under inspection. Shape recovery module 140 also generally comprises an E-glass transparency control module 145 for control over the transparency modes of each of the plural E-glass layers 103, a projector pattern control module 146 which stores plural sequences of patterned light patterns and which controls projection of the plural sequences of patterned light patterns by projector 101, as well as image capture control module 147 for control of image capture by image capturing system 102.

Unshown in FIG. 7 is a further module, also stored in non-volatile memory 160, for control over the pair of polarizers, so as to rotate the polarizer and/or the analyzer and alter the state of polarization.

Positioning control module 150 controls repositioning of the object on movable stage 14, and replication control module 160 controls replication controller 104 for 3D replication of the object.

With respect to movable stage 14, reconstructor 100 issues positioning commands to reposition movable stage 14 and the object thereon. At each position, by control over the E-glass layers and pattern projection, the 3D shape of the entirety of the visible surface of the object, at that position, can be reconstructed. Repositioning of the object exposes other areas of its surface to image capture and illumination by the layers, and thereby permits 3D shape reconstruction with as much of the entirety of the object as desired.

The computer-executable process steps for these modules may be configured as part of operating system 118, as part of an output device driver in output device drivers 121, or as a stand-alone application program(s). These modules may also be configured as a plug-in or dynamic link library (DLL) to the operating system, device driver or application program. It can be appreciated that the present disclosure is not limited to these embodiments and that the disclosed modules may be used in other environments.

Separation of Light Components (with Circular Polarization)

Consider an E-glass based system modified using the arrangement described above, where both polarizer and analyzer are fixed and have circular polarization.

If both polarizer and analyzer have the same sense of polarization (i.e., both are left-handed or right-handed), from Property 4 the specular component reflected from the object has a reversed polarization. From Property 2 and Property 3b, only the diffuse component will be measured at the pixel p:

$${I}_{1} ( p ) = \frac{1}{2} {I}^{d} ( p )$$

If polarizer and analyzers have opposite circular polarization, then the measured intensity will correspond to the sum of both components:

$${I}_{2} ( p ) = \frac{1}{2} [ {I}^{s} ( p ) + {I}^{d} ( p ) ]$$

The original diffuse and specular components can then be extracted from I₁ and I₂:

I^{d}(p)=2I₁(p)

I^{s}(p)=2[I₂(p)−I₁(p)]

The main assumption here is that the polarization reaching the analyzer is circular. From Property 5, this is true only when the angle between the light source and the camera is less than 60°.

Separation of Light Components (with Linear Polarization)

Consider an E-glass based system modified using the arrangement described above with linear polarization, where the polarizer is fixed (incident light has a fixed polarization) and the analyzer rotates by N angles.

From Property 3a in the previous section, the intensity of the image Iₖ captured at the angle θₖ can be described as the sum of the diffuse and (part of) the specular components:

$${I}_{k} = {I}^{s} {cos}^{2} {θ}_{k} + \frac{1}{2} {I}^{d} \qquad Equation ( 1 )$$

where k={1, . . . , N}

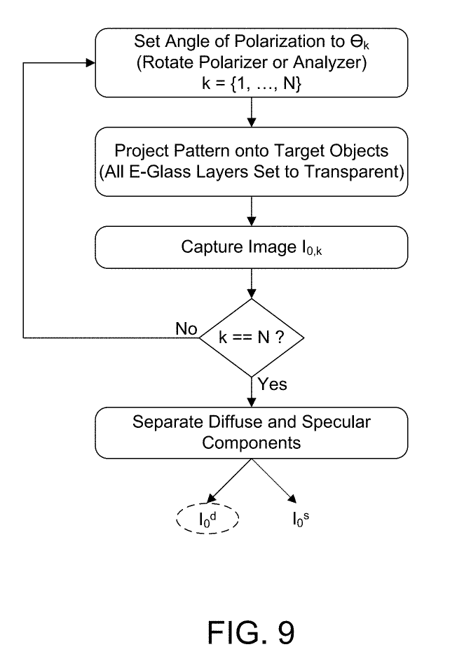

FIG. 8A and FIG. 8B show two examples of how the intensity Iₖ varies at a pixel p of a glossy object depending on the angle of rotation θₖ of the analyzer. FIG. 8A assumes the surface of the object to be highly glossy while FIG. 8B assumes low glossiness. The same effect can be obtained if, in the same setup, the analyzer is fixed and the polarizer rotates.

### Extraction of Diffuse and Specular Components

The proposed separation method can be divided in two main procedures:

Procedure #1: Extract diffuse component I^{d} for shape reconstruction

Procedure #2: Extract specular component I^{s} for shape reconstruction

### Procedure #1: Extract Diffuse Component for Shape Reconstruction

All M layers of the E-glass layers are set to transparent and a pattern is projected onto the target object. The camera captures N images of the same scene; each image I_{0,k}^{d} corresponds to a rotation θₖ of the analyzer.

In one embodiment, the analyzer is fixed and the N rotations correspond to the angles of the polarizer.

Based on what has been described before and shown in FIG. 8A and FIG. 8B, for each pixel p the diffuse component can be extracted by minimizing the N intensity values I_{0,k}(p):

$${I}_{0}^{d} ( p ) = {min}_{k} {I}_{0 , k} ( p )$$

In one embodiment, I₀^{d}(p) is the minimum of the curve fitted through the measurements I_{0,k}(p), using Equation 1.

In one embodiment, I₀^{d}(p) is the value captured with a rotation \hat{θ}ₖ, where \hat{θ}ₖ is the angle that corresponds to the minimum of the curve fitted (using Equation 1) through three (3) measurements I_{0,k}(p), taken with linear polarizations spaced 60° apart.

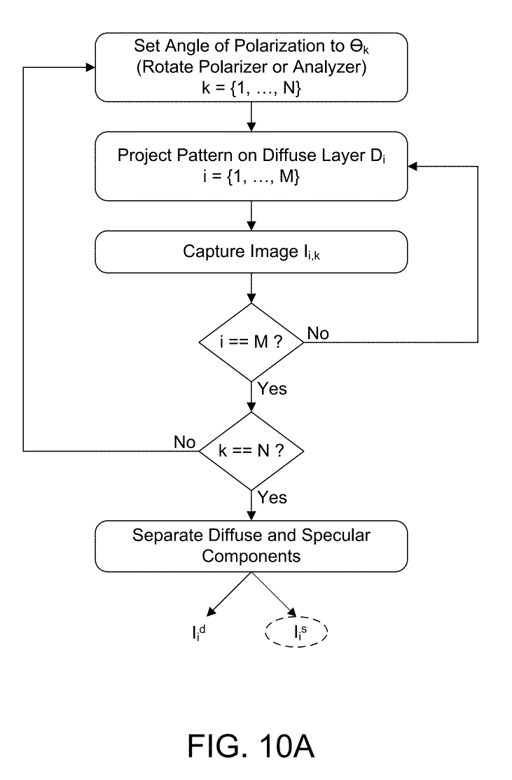

This procedure is also summarized in the flowchart of FIG. 9.

FIG. 9 is a flowchart for explaining extraction of a diffuse component for surface reconstruction. The extracted component I₀^{d} is used for shape reconstruction.

### Procedure #2: Extract Specular Component for Shape Reconstruction

The specular component for shape reconstruction is extracted using N×M captured images. More specifically, for each E-glass layer Dᵢ (with iε{1, . . . , M}):

Step a: Project pattern on Dᵢ by setting Dᵢ to diffuse and all the other layers to transparent

Step b: Capture N images, one per each rotation θₖ of the analyzer.

In one embodiment, the analyzer is fixed and the N rotations correspond to the angles of the polarizer.

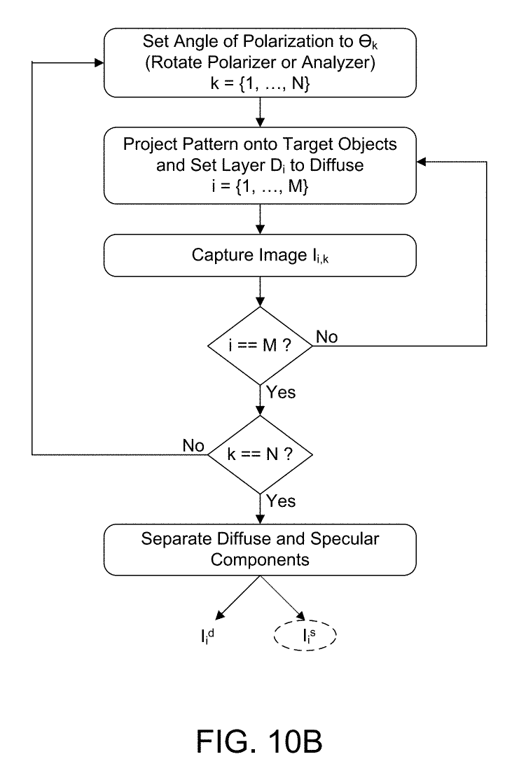

This procedure is also summarized in the flowchart of FIG. 10A for the arrangement shown in FIG. 6A where the projector is positioned to project onto the object, and is summarized in FIG. 10B for the arrangement shown in FIG. 6B where the projector is positioned to project onto the E-glass layers.

Based on what has been described before and shown in the intensity variation graphs of FIG. 8A and FIG. 8B, for each pixel p, the diffuse component can be extracted at each layer Dᵢ by minimizing the N intensity values I_{i,k}^{d}(p):

$${I}_{i}^{d} ( p ) = {min}_{k} {I}_{i , k} ( p )$$

with iε{1, . . . , M} and M is the number of E-glass layers.

In one embodiment, Iᵢ^{d}(p) is the minimum of the curve fitted through the measurements I_{i,k}(p), using Equation 1.

In one embodiment, Iᵢ^{d}(p) is the value captured with a rotation \hat{θ}ₖ, where \hat{θ}ₖ is the angle that corresponds to the minimum of the curve fitted (using Equation 1) through three (3) measurements I_{i,k}(p), taken with linear polarizations spaced 60° apart.

The specular component can then be extracted for each E-glass layer Dᵢ:

Iᵢ^{s}(p)=Iᵢ^{max}(p)−Iᵢ^{d}(p)

where Iᵢ^{max} corresponds to the reflected image of the layer Dᵢ where no intensity of the glossy object has been reduced:

$${I}_{i}^{max} ( p ) = {max}_{k} {I}_{i , k} ( p )$$

In one embodiment, Iᵢ^{max}(p) is the maximum of the curved fitted through the measurements I_{i,k}(p).

In one embodiment, Iᵢ^{max} is considered to be the image captured without the analyzer, and the specular component can be extracted as:

Iᵢ^{s}(p)=Iᵢ^{max}(p)−2Iᵢ^{d}(p)

### Shape Reconstruction

Shape of the target object can be reconstructed from both the diffuse component I₀^{d} and the set of specular components {I₁^{s}, I₂^{s}, . . . , I_{M}^{s}} either independently or jointly.

In one embodiment, the shape is reconstructed independently:

1. The diffuse component using a shape reconstruction method for diffuse objects;

2. The set of specular components using a shape reconstruction method for specular objects;

The two shape results are then fused using a weighted average at each pixel p:

S(p)=α(p)S^{s}(p)+(1−α(p))S^{d}(p)

with αε[0,1],

where S^{s} is the shape information (e.g, depth map or normal value) from the specular components and S^{d} is the shape information from the diffuse component I₀^{d}.

In one embodiment, the weights α(p) are extracted from the ratio between the intensities of the specular and the diffuse components.

In one embodiment, the weights α(p) are assumed to be constant across the whole image.

### <Computer Implementation>

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU typically includes software resident on a storage media (e.g., a disk drive or memory card), which, when executed, directs the CPU in performing transmission and reception functions. The CPU software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

What is claimed is:

1. A system to separate diffuse and specular components of a glossy object, the system comprising:
at least two E-glass layers positioned in spaced-apart relation relative to each other, wherein each of the two E-glass layers can be set to either transparent mode or diffuse mode;
at least one projector to project patterned light toward the glossy object;
at least one camera to capture images of light reflected from the glossy object;
at least one polarizer to polarize light incident on the glossy object before it reaches the glossy object;
at least one analyzer to analyze the light reflected from the glossy object.

2. The system according to claim 1, wherein both the polarizer and the analyzer are circular.

3. The system according to claim 1, wherein both the polarizer and the analyzer are linear.

4. The system according to claim 3, wherein the polarizer is fixed and the analyzer rotates.

5. The system according to claim 3, wherein the polarizer rotates and the analyzer is fixed.

6. The apparatus according to claim 1, wherein the two E-glass layers are positioned between the projector and the glossy object,
wherein the projector is controlled to project patterned light toward the glossy object through the two E-glass layers when the two E-glass layers are set to transparent mode and polarization of at least one of the polarizer and the analyzer is varied,
wherein the camera is controlled to capture images of light reflected from the glossy object towards the camera when the two E-glass layers are set to transparent mode,
wherein the projector is controlled to project patterned light toward the glossy object onto alternating ones of the two E-glass layers when such one of the two E-glass layers is set to diffuse mode and polarization of at least one of the polarizer and the analyzer is varied, and
wherein the camera is controlled to capture images of patterned light reflected by the glossy object from such one of the two E-glass layers when such one of the two E-glass layers is set to diffuse mode.

7. The apparatus according to claim 1, wherein the two E-glass layers are positioned between the camera and the glossy object,
wherein the projector is controlled to project patterned light toward the glossy object for reflection by the glossy object through the two E-glass layers when the two E-glass layers are set to transparent mode and polarization of at least one of the polarizer and the analyzer is varied,
wherein the camera is controlled to capture images of light reflected from the glossy object towards the camera through the two E-glass layers when the two E-glass layers are set to transparent mode,
wherein the projector is controlled to project patterned light toward the glossy object for reflection by the glossy object onto alternating ones of the two E-glass layers when such one of the two E-glass layers is set to diffuse mode and polarization of at least one of the polarizer and the analyzer is varied, and
wherein the camera is controlled to capture images of patterned light reflected by the glossy object onto such one of the two E-glass layers when such one of the two E-glass layers is set to diffuse mode.

8. A method to separate diffuse and specular components of reflection from a glossy object for shape reconstruction, the method comprising:
controlling first and second transparency-controllable layers between a transparent mode in which the layer is transparent and a diffuse mode in which the layer diffuses light, wherein the first and second layers are positioned in spaced-apart relation relative to each other;
projecting patterned light from a projector such that the object is illuminated with patterned light;
capturing images of the object with different angles of polarization;
using the captured images to extract a diffuse component of reflection and a specular component of reflection.

9. The method according to claim 8, wherein all the layers are set to transparent and the pattern is projected directly onto the target object.

10. The method according to claim 8, wherein only one layer is set to diffuse and all the other layers are set to transparent, and the projected pattern is displayed on the diffuse layer.

11. The method according to claim 10, wherein N images are captured for each layer in accordance with N variations in angle of polarization.

12. The method according to claim 8, wherein the diffuse component of reflection is extracted in accordance with a minimum in the captured images across the different angles of polarization.

13. The method according to claim 12, wherein the specular component of reflection is extracted in accordance with a maximum in the captured images across the different angles of polarization.

14. The method according to claim 13, wherein the diffuse and the specular components are extracted by fitting a curve across the different angles of polarization.

15. A method for shape reconstruction comprising:
shape reconstruction of diffuse components of reflection for an object;
shape reconstruction of specular components of reflection for the object; and
combining the shape reconstruction of diffuse components of reflection for the object and the shape reconstruction of specular components of reflection for the object by using a weighted average.

16. The method according to claim 15, wherein the weights are extracted using a ratio between intensities of the specular and the diffuse components.

17. The method according to claim 15, wherein the weights are computed at each pixel.

18. The method according to claim 15, wherein the weights are constant for the entire image.

19. An apparatus for depth estimation of the surface of an object positioned at an inspection station, the apparatus comprising:
first and second transparency-controllable layers, the first and second layers being positioned in spaced-apart relation relative to each other, wherein both of the first and second layers are controllably switchable between a transparent mode in which the layer is transparent, and a diffuse mode in which the layer diffuses light;
a projector positioned and configured to project patterned light, whereby the inspection station is illuminated with patterned light;
an image capture device positioned and configured to capture images of light reflected from an object at the inspection station;
first and second polarizers, the first polarizer being positioned to polarize incident light before it reaches the object and the second polarizer being configured as an analyzer to analyze the light reflected from the object; and
a controller configured (i) to control transparency of the first and second layers and to control projection of patterned light by the projector, (ii) to control at least one of the first polarizer and the second polarizer so as to vary polarization of light, (iii) to separate diffuse components of reflected light from specular components of reflected light by calculations using images of the object captured by the image capture device, and (iv) to estimate depth of the surface of an object positioned at the inspection station.

20. The apparatus according to claim 19, wherein the diffuse component of reflection is extracted in accordance with a minimum in the captured images across the different angles of polarization.

21. The apparatus according to claim 20, wherein the specular component of reflection is extracted in accordance with a maximum in the captured images across the different angles of polarization.

22. The apparatus according to claim 21, wherein the diffuse and the specular components are extracted by fitting a curve across the different angles of polarization.

23. The apparatus according to claim 19, wherein the controller is further configured to:
reconstruct shape based on the diffuse component to reconstruct shape based on the specular component; and
fuse the shape reconstruction based on the diffuse component and the shape reconstruction based on the specular component.

24. The apparatus according to claim 23, wherein fusing uses a weighted average of the shape reconstruction based on the diffuse component and the shape reconstruction based on the specular component.

25. The apparatus according to claim 23, wherein the weights are extracted using a ratio between intensities of the specular and the diffuse components.

26. The apparatus according to claim 19, wherein the projector is positioned to project patterned light toward the first and second transparency-controllable layers.

27. The apparatus according to claim 19, wherein the projector is positioned to project patterned light toward the inspection station.

28. A method for estimating depth of the surface of an object, the method comprising:
controlling first and second transparency-controllable layers between a transparent mode in which the layer is transparent and a diffuse mode in which the layer diffuses light, wherein the first and second layers are positioned in spaced-apart relation relative to each other;
projecting a first sequence of light patterns while the first layer is in the diffuse mode and the second layer is in the transparent mode, wherein the object is illuminated with the projected light patterns;
projecting a second sequence of light patterns while the first layer is in the transparent mode and the second layer is in the diffuse mode, wherein the object is illuminated with the projected light patterns;
varying a degree of polarization of light incident on the object;
repeating the projection of the first and second sequences of light patterns and control over diffuse and transparent modes of the first and second layers;
capturing images of deformed patterns reflected by the surface of the object under both repetitions of the first and second sequences, the images being captured through a polarization analyzer;
repeating the projection of the first and second sequences of light patterns while both layers are in the transparent mode;
capturing images of the object under projection by the first and second sequences of light patterns while both layers are in the transparent mode;
extracting a diffuse component of reflection by using the captured images;
extracting a specular component of reflection by using the captured images under polarized illumination; and
estimating depth of the surface of the object by fusing the diffuse component and the specular component.

29. The apparatus according to claim 28, wherein the diffuse component of reflection is extracted in accordance with a minimum in the captured images across the different angles of polarization.

30. The apparatus according to claim 29, wherein the specular component of reflection is extracted in accordance with a maximum in the captured images across the different angles of polarization.

31. The apparatus according to claim 30, wherein the diffuse and the specular components are extracted by fitting a curve across the different angles of polarization.

32. The apparatus according to claim 28, wherein fusing uses a weighted average of the diffuse component and the specular component.

33. The apparatus according to claim 28, wherein the weights are extracted using a ratio between intensities of the specular and the diffuse components.
